(19) United States
(12) Patent Application Publication
(10) Pub. No.: US 2009/0240175 A1
(43) Pub. Date: Sep. 24, 2009

(54) Scalp Massager

(76) Inventor: Aileen Castino Clementes, Arlington, TX (US)

Correspondence Address: Aileen C. Clementes, 1307 Willoughby Lane, #5415, Arlington, TX, 76011, US

(21) Appl. No.: 12/142,786

(22) Filed: Jun. 20, 2008

Related U.S. Application Data
(60) Provisional application No. 61/070,059, filed on Mar. 20, 2008.

(51) Int. Cl. A61H 7/00

(52) U.S. Cl. 601/133; 601/135

(57) ABSTRACT

A manual scalp massager simulating the effect of two sets of fingers placed at two bipolar transverse positions opposing each other to squeeze the scalp skin together in a “broad-pinching” action. The device comprises two jaw-like members lined at each opposing edge with a row of closely-packed fingertip-like rubber spheres. The embodiment is supported by two pairs of A-shaped frames hinged at each vertex where the pair of jaw members is attached to one pair of distal ends, while handlebars are attached to the other pair of distal ends. Coupled with the highly-tacky fingertip-shaped rubber protrusions to maximize gripping of the tightly drawn scalp skin, this simultaneous downward and lateral pressure applied to the jaw members squeezes the contacting scalp skin without pulling the surrounding hair thereby stimulating the scalp through the “squeezing-out” of its old fatty oils, increases flow of the blood vessels, and helps promote hair growth.

### CROSS-REFERENCE TO RELATED APPLICATIONS

The present non-provisional patent application entitled “Scalp Massager” claims the benefits of, relies on the priority of, improves upon, and enhances the subject matter of the previously-filed provisional patent application Ser. No. 61/070,059, filed Mar. 20, 2008.

US Patent References:

| | | |
|---|---|---|
| 2465250 | March 1949 | McCready |
| 2706980 | April 1955 | Kahn |
| 3633571 | January 1972 | Shinagawa |
| 4744350 | May 1988 | Sato |
| 6190339 | February 2001 | Imazaike et al |
| 7153282 | December 2006 | Dudley |

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

(1) Technical Field

The invention relates to a massaging device and more specifically, a scalp massager that will stimulate the blood vessels of the scalp and help promote growth of healthy hair.

(2) Background Art

It is well known that some cases of premature hair loss and thinning hair are attributed to the lack of skin stimulation in the scalp. Vibratory scalp massagers are common in the patented prior art, while some devices massage the scalp using the approach of: circulatory motion, U.S. Pat. No. 6,190,339; gyratory impulses U.S. Pat. No. 2,465,250; lateral or rolling motion, U.S. Pat. No. 4,744,350; finger-simulation, U.S. Pat. Nos. 2,706,980. 7,153,282. 3,633,571.

Although these devices are suitable for its respective main objectives, they would not be suitable for the purpose of the present invention as disclosed hereafter. For instance, the currently patented finger-simulation devices are not designed to grip the scalp and “squeeze-out” its old fatty oils secreted by the sebaceous glands. The present invention has two jaw members with fingertip-like rubber protrusions which simulates the effects of two sets of fingers reciprocally opposing each other combining with a downward lateral force to squeeze the tightly-drawn scalp skin in a “broad pinching” action without pulling the surrounding hair. This is accomplished with the two jaw members' fingertip-like rubber protrusions laterally opposing each other to squeeze and contract the contacting scalp skin, whether in a quick rhythmic pace or in an extended long-hold period. Massaging the scalp in this manner using ones hands and fingers alone without the use of the present invention is beneficial to hair health but can be very strenuous and tiring.

The present invention is hand-held, manually-operated and water-resistant with a design that allows the user to vary the desired pace and intensity whether in a quick rhythmic pace or in an extended long-hold period which is not easily achieved with the same effectiveness in motor-driven devices. Moreover, the design of the said invention allows the user to apply as much downward force, not easily recommended for motor-driven devices, which is integral to the effectiveness of the implementation to grip the scalp and “squeeze-out” the old sebum oils of the sebaceous glands without pulling the surrounding hair and stimulate the flow of new sebum oils and of the blood vessel.

Many of the prior art are also bulky, complex and expensive to manufacture. This present invention will be easy to operate, relatively low-cost, water-resistant and simple to manufacture.

There are various scalp massagers available which do not provide the novel improvements of the invention herein disclosed.

### BRIEF SUMMARY OF THE INVENTION

A primary objective of the present invention is to simulate the effects of two sets of fingers placed at two bipolar transverse positions and reciprocally opposing each other combining with a downward lateral force to squeeze the tightly-drawn scalp skin together in a “broad pinching” action without pulling the surrounding hair. This is accomplished with the two jaw members' fingertip-like rubber protrusions laterally opposing each other to squeeze and contract the scalp skin, whether in a quick rhythmic pace or in an extended long-hold period. This action results in the stimulation of the blood vessels and secretion of the old fatty oils of the sebaceous glands inducing the flow of new natural oils, and helps promote the growth of healthy hair. Massaging the scalp with just the hands and fingers alone in this manner without the aid of the present invention is extremely beneficial to scalp and hair health but can be very strenuous and tiring. The design of the said invention allows the user to apply as much downward force, not easily recommended for motor-driven devices, which is integral to the effectiveness of the said invention to grip the scalp and “squeeze-out” the scalp's natural oils and agitate the flow of blood vessels. Moreover, coupled with the highly-tacky material of the fingertip-shaped spherical protrusions that maximizes gripping of the scalp skin, this simultaneous downward and lateral pressure by the jaw members squeezes the contacting scalp without pulling or affecting the surrounding hair.

Another objective of the invention is to provide a manual, hand-held, water-resistant device that simulates finger-pressured scalp massage that is an improvement over prior implements by its simplicity in design and ease of manufacture, maintenance, cost & operation.

Another objective is to provide a massage implementation that improves on the user's control of the variation of motion, pace & intensity, and applied downward & squeezing force according the user's preference which is not easily duplicated by a motor-driven implementation.

Another objective of the present invention being non-motor-driven and water-resistant is its ability to operate in wet areas, such as the shower, where scalp massaging is known to be a common practice.

### BRIEF DESCRIPTION OF THE SEVERAL VIEWS OF THE DRAWING(S)

FIG. 1 is a bottom elevation view of the invention

FIG. 2 is a bottom perspective view of the invention

FIG. 3 is a top elevation view of the invention

FIG. 4 is a top view of the invention

FIG. 5 is a side elevation view of the invention

FIG. 6 is a top perspective view of the invention

FIG. 7 is a bottom view of the invention

### DETAILED DESCRIPTION OF THE INVENTION, INCLUDING THE BEST MODE OF CARRYING OUT THE INVENTION

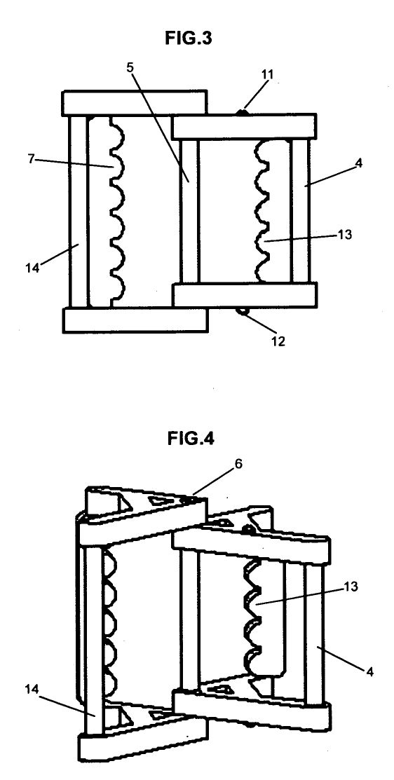

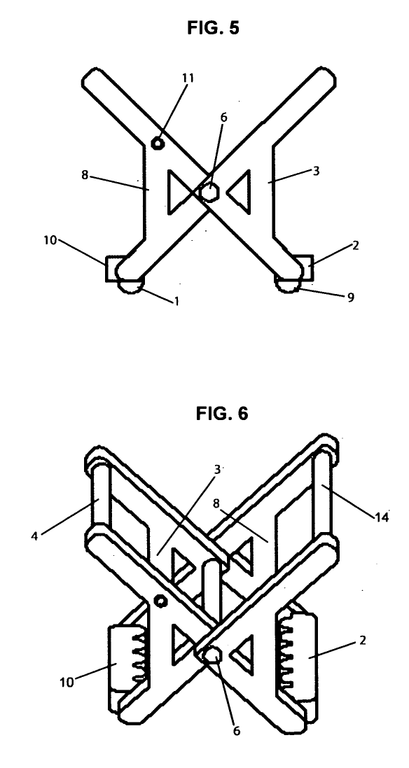

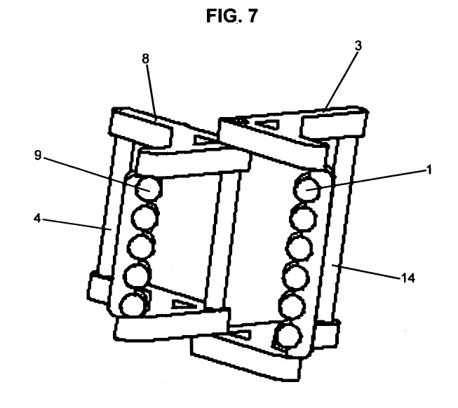

Referring to the embodiment in FIG. 2 the invention has a main body in the form of two pairs of horizontal A-shaped frames 3, 8 symmetrically opposing each other but coupled to each other by a cylindrical shaft (FIG. 3) 5 attached to each hinge (FIG. 6) 6 of each pair of A-shaped frames 3, 8.

The upper portion of the embodiment has a pair of handle bars (FIG. 6) 4, 14 respectively attached to the distal ends of each pair of the lever members of the A-shaped frames 3, 8.

The lower portion of the embodiment as indicated in FIG. 2 has a pair of support shaft or “jaw” members 2, 10 respectively attached to the distal ends of each pair of the lever members of the A-shaped frames 3, 8.

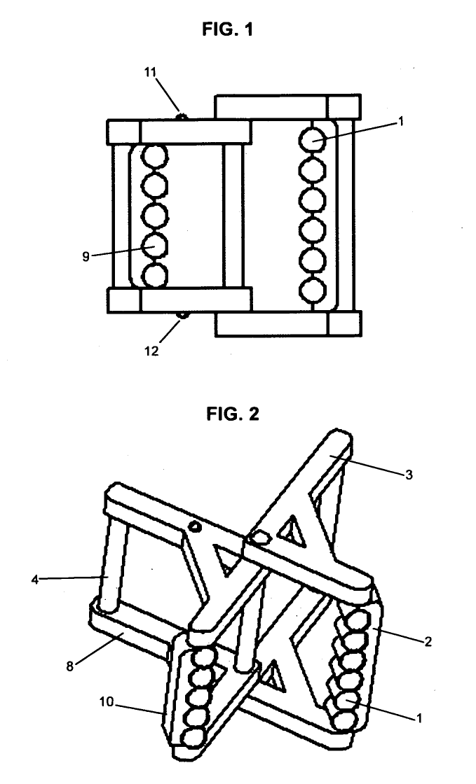

The underside of each support shaft or “jaw” members 2, 10 has a multiplicity of cavities (FIG. 3) 7, 13 along the inner side opposite each shaft whereby a row of closely packed fingertip-sized rubber spheres (FIG. 1) 1, 9 are embedded halfway in and protruding from the said support shafts 2, 10. The edge of each inner side of the said support shafts 2, 10 is designed of a plurality of U-shaped patterns 7, 13 to house the said spherical widgets 1, 9.

Each A-shaped body element 3, 8 is coupled to the other at the vertex by a hinge 6 for pivoting movement about an axis perpendicular to the plane of the A-shaped frames 3, 8.

Another feature of the embodiment as indicated in FIG. 1 includes a small protrusion 11, 12 on each outer-side of the embodiment to limit the range of motion of the user so as to keep the user's hands from colliding with each other.

The number of cavities 7, 13 and rubber widgets 1, 9 depicted in the drawing is five (5) for the lower jaw and six (6) for the upper jaw of each support shaft 2, 10. The preferred number of cavities 7, 13 and rubber widgets 1, 9 for each jaw member 2, 10 is approximately from two (2) to ten (10) depending on the size of the cavities 7, 13 and rubber widgets 1, 9, as well as, the length of the jaw member 2, 10.

The preferred mode of usage of the scalp massager is by holding the embodiment at both of the handle grips 4, 14 with both hands onto the users head, with the two “jaw” members 2, 10 sitting on the user's scalp placed on two bipolar transverse positions opposing each other, and firmly pulling-down/pushing-up alternately on the handle grip portions 4, 14. As the “jaw” base 2, 10 closes onto each other during the pulling-down motion the scalp is squeezed onto itself firmly between the contact points, which are the rubber widgets 1, 9 opposite each other, to simulate a broad-pinching action.

While the present invention shown and described herein in what are conceived to be the most practical and preferred embodiments, it is recognized that departures may be made from within the scope of the invention, which is therefore not to be limited to the details disclosed herein, but is to be afforded the full scope of the claims so as to embrace any and all equivalent apparatus and articles.

What is claimed is:

1. A scalp massaging device comprising:
Two pairs of A-shaped framesets wherein a pair is composed of one A-shaped frame riveted at the vertex to a second opposing inverted A-shaped frame overlapping the first at their respective vertex forming a pivot; two handle bars wherein each handle bar links one A-shaped frameset to its symmetrically opposing counterpart at each A-shaped frame's upper distal ends; two support shafts serves as the jaw members of the embodiment, links the two said A-shaped framesets together at the lower portion of the embodiment by connecting the support shaft ends at the remaining distal ends of the said A-shaped framesets whereby the shape of the opposing edges of each said jaw members is a series of U-shaped patterns to house a plurality of cavities along its underside; a pivot shaft, placed parallel to the axis of motion of the embodiment and also parallel to both the two handle bars and the two support shafts, where each end is connected to the riveted pivot of each A-shaped frameset creates a hinge at the fulcrum of the embodiment; a multiplicity of fingertip-sized cavities along the inner edge of the underside of the said jaw members; a row of closely packed fingertip-sized spheres, composed of rubber or a highly tacky material, embedded halfway-in and protruding from each of the said cavities of the said jaw members.

2. The invention set forth in claim 1, wherein the said two handlebar portions of the embodiment are substituted by two palm-sized spheres ideal for grasping; the open ends of each pair of lever members distal from each hinge of the embodiment as described in claim 1 will intersect and connect with the corresponding spherical handles.

3. The invention set forth in claim 1, wherein the surfaces of the said fingertip-shaped spherical protrusions that contact the scalp are grooved or serrated to achieve maximum gripping of the scalp.

4. The invention set forth in claim 1, wherein the said upper and lower jaw members have a plurality of fingertip-shaped rubber widgets arranged along the edges of the jaw members' longitudinal axis in the following pattern configurations: Zigzag-shaped, S-shaped, straight-line.

5. The invention set forth in claim 1, wherein the structural design of the embodiment is a departure from the said embodiment but is within the scope of the objective of the invention; such as the structural A-shaped frames of the said lever members being substituted with the following configurations: V-shaped, U-shaped, H-shaped.

6. The invention set forth in claim 1, wherein the said jaw members are constructed of a stiff but bendable metal frame so as to slightly curve along its axis if downward pressure is applied thereby conforming to the shape of the subject.
